(19) United States
(12) Patent Application Publication
(10) Pub. No.: US 2019/0208000 A1
(43) Pub. Date: Jul. 4, 2019

(54) MEDIA STREAMING CONTROL DEVICE AND CONTROL METHOD THEREOF

(71) Applicant: AVerMedia Technologies, Inc., New Taipei City (TW)

(72) Inventors: Po-Yang Yao, New Taipei City (TW); Hsiang-Yi Ma, New Taipei City (TW); Nian-Ying Tsai, New Taipei City (TW)

(21) Appl. No.: 16/232,183

(22) Filed: Dec. 26, 2018

(30) Foreign Application Priority Data
Dec. 29, 2017 (TW) 106146461

(51) Int. Cl. H04L 29/06; G06F 16/43

(52) U.S. Cl. CPC H04L 65/605; H04L 67/306; H04L 63/083; G06F 16/43

(57) ABSTRACT

A media streaming control device is cooperated with a media output device at local side, the media streaming control device includes a selecting unit, a querying unit, a detecting unit and a calculating unit, the selecting unit selects at least one media stream platform at remote side, and selects at least one media source from the at least one media stream platform, the querying unit queries media parameter limitations of the selected media stream platform, the detecting unit detects system performance of a personal computing device at local side, and the calculating unit calculates a set of optimal media parameters based on the queried media parameter limitations and the detected system performance, the calculating device further configures the selected media source based on the set of optimal media parameters, and the configured media source is output through the media output device.

### CROSS REFERENCE TO RELATED APPLICATIONS

This Non-provisional application claims priority under 35 U.S.C. § 119(a) on Patent Application No. 106146461 filed in Republic of China on Dec. 29, 2017, the entire contents of which are hereby incorporated by reference.

### BACKGROUND

### 1. Technical Field

The present invention relates to a media control device and a control method thereof, in particular to a control device of controlling parameters of a streaming media source and a control method thereof

### 2. Description of Related Art

Technology advances with the times, and various network streaming media platforms have been around for years, such as YouTube, Facebook and Twitch. A user often opens multiple windows or applications simultaneously on an identical personal calculating device (for example, a personal computer or a tablet computer), to play different media sources from different streaming platforms simultaneously. However, system performance of the personal calculating device may be consumed seriously if more than two streaming media playing processes run on the identical device simultaneously, thereby greatly reducing the whole operating smoothness of the personal calculating device and making the streaming media playing trapped in delay or freeze-frame and other problems. In addition, playing of multiple streaming media sources by simultaneously opening multiple applications or multiple windows may cause inconvenience to the user during operation as well.

In order to overcome the above-mentioned problems, three conventional technologies have been proposed. In the first conventional technology, multiple OBS applications are started simultaneously, account numbers are used to log in respectively and streaming buttons are clicked individually, to achieve simultaneous streaming between multiple platforms. However, the user may not remember each streaming account number and each setting, and may be required to fill out information again before using each time. Moreover, a screen of the identical device may play one streaming platform only, and may not capture contents of the identical device. Furthermore, the user must keep trying various parameter settings because the performance of the computer to play the streaming platform is unknown. In addition, a streaming object platform must be set manually after individual inquiry, and it is relatively difficult for a new user.

In the secondary conventional technology, a Nginx application is taken, which may implement forwarding to multiple streaming platforms through setting up a local server. However, the Nginx application has the following disadvantages: identical encoded data may be forwarded only, and data of different resolutions and bit-rates may not be processed.

In the third conventional technology, a third platform Restream is taken, which transmits the data to a dedicated server of Restream and selects the streaming platform through a dedicated webpage, with convenient setting and bandwidth saving. However, Restream has the following disadvantages: the user is required to pay for advanced setting of streaming parameters, and there may be a great delay in the aspect of live streaming speed and watching, and the streaming platform may be limited as well because the dedicated server of Restream is located at North America.

Therefore, how to provide an effective media streaming control device and an effective media streaming control method is of utmost urgency. Herein, the media streaming control device and the media streaming control method may simultaneously play multiple streaming media sources from different streaming platforms with a single application or a single device. In addition, the media streaming control device may be operated conveniently, and the user may not need to voluntarily and additionally inquire parameter limitations of each streaming platform, nor set parameters individually in allusion to different streaming platforms and voluntarily inquire the system performance of the local personal calculating device. The provided media streaming control device and the provided media streaming control method may implement automatic inquiry and setting. How to provide this kind of full automatic media streaming control device and full automatic media streaming control method is one of important subject at present.

### SUMMARY OF THE INVENTION

It is therefore an object of the present invention to provide a media streaming control device. The media streaming control device is used jointly with a local media output device and includes a selecting unit, an querying unit, a detecting unit and a calculating unit. The selecting unit selects at least one remote media streaming platform and at least one media source from media streaming platforms. The querying unit inquires a media parameter limitation of the selected media streaming platform. The detecting unit detects system performance of a local personal calculating device. The calculating unit calculates a set of optimized media parameters in accordance with the queried media parameter limitation and the detected system performance while setting the selected media sources in accordance with the set of optimized media parameters and outputting the media sources after setting through the local media output device.

In one embodiment of the present invention, wherein the media parameters include image resolution, image bit-rate, image frame-rate or audio bit-rate of the media source.

In one embodiment of the present invention, the media parameter limitations are stored in a database of a remote server, and the querying unit may access to the database through network connection to inquire the media parameter limitations.

In one embodiment of the present invention, the system performance of the personal calculating device includes main frequency of a Central Processing Unit (CPU), scope of the image resolution compatible with a Graphics Processing Unit (GPU), memory capacity and type of an image encoder compatible with software.

In one embodiment of the present invention, the calculating unit calculates the set of optimized media parameters after choosing a maximum in an intersection of the media parameter limitations and the system performance.

In one embodiment of the present invention, wherein the user may adjust the set of optimized media parameters manually.

In one embodiment of the present invention, wherein the media streaming control device further includes a storing unit, which is configured to store the set of optimized media parameters.

Another objective of the present invention is to provide a media streaming control method, to set media parameters of at least one media source output by a local media output device. The media streaming control method includes: at least one remote media streaming platform and at least one media source of the media streaming platforms are selected, an automatic parameter setting process is implemented to generate one set of optimized media parameters automatically, the selected media sources are set in accordance with the set of optimized media parameters, and the media sources after setting are output through the media output device.

In one embodiment of the present invention, wherein the step of setting the parameter process automatically includes the following steps: an media parameter limitation of the selected media streaming platform is queried automatically, system performance of a local personal calculating device is detected automatically, and the set of optimized media parameters are calculated automatically in accordance with the queried media parameter limitations and the detected system performance.

In one embodiment of the present invention, wherein the media parameters include image resolution, image bit-rate, image frame-rate or audio bit-rate of the media source.

In one embodiment of the present invention, wherein the system performance of the personal calculating device includes main frequency of a Central Processing Unit (CPU), scope of the image resolution compatible with a Graphics Processing Unit (GPU), memory capacity and type of an image encoder compatible with software.

In one embodiment of the present invention, wherein in the automatic calculation step of the automatic parameter setting process, the set of optimized media parameters are calculated by choosing a maximum in an intersection of the media parameter limitations and the system performance.

In one embodiment of the present invention, wherein the media streaming control method further includes a manual parameter setting process. Herein, a user may adjust the set of optimized media parameters manually.

In one embodiment of the present invention, wherein the media streaming control method further includes: the set of optimized media parameters are stored, and the media parameters of at least one media source to be selected next time are set in accordance with the set of optimized media parameters that are stored this time when selecting the identical media streaming platform next time.

In one embodiment of the present invention, wherein the media streaming control method further includes: a login account number and a password of the selected media streaming platforms are stored, and the account number and the password which are stored this time are taken to log in when selecting the identical media streaming platform next time.

The detailed technology and preferred embodiments implemented for the subject invention are described in the following paragraphs accompanying the appended drawings for people skilled in this field to well appreciate the features of the claimed invention.

### BRIEF DESCRIPTION OF THE DRAWINGS

The parts in the drawings are not necessarily drawn to scale, the emphasis instead being placed upon clearly illustrating the principles of at least one embodiment. In the drawings, like reference numerals designate corresponding parts throughout the various diagrams, and all the diagrams are schematic.

FIG. 1 is a schematic diagram showing a media streaming control device in accordance with a first preferred embodiment of the present invention.

FIG. 2 is a schematic diagram showing a query mode of the querying unit of the media streaming control device in accordance with a first preferred embodiment of the present invention.

FIG. 3 is a schematic diagram showing a detection mode of the detecting unit of the media streaming control device in accordance with a first preferred embodiment of the present invention.

FIG. 4 is a flow chart showing a media streaming control method in accordance with the first to the fourth embodiments of the present invention.

FIG. 5 is a flow chart showing the automatic parameter setting process in the media streaming control method of the first to the fourth embodiments of the present invention.

### DETAILED DESCRIPTION

Reference will now be made to the drawings to describe various inventive embodiments of the present disclosure in detail, wherein like numerals refer to like elements throughout.

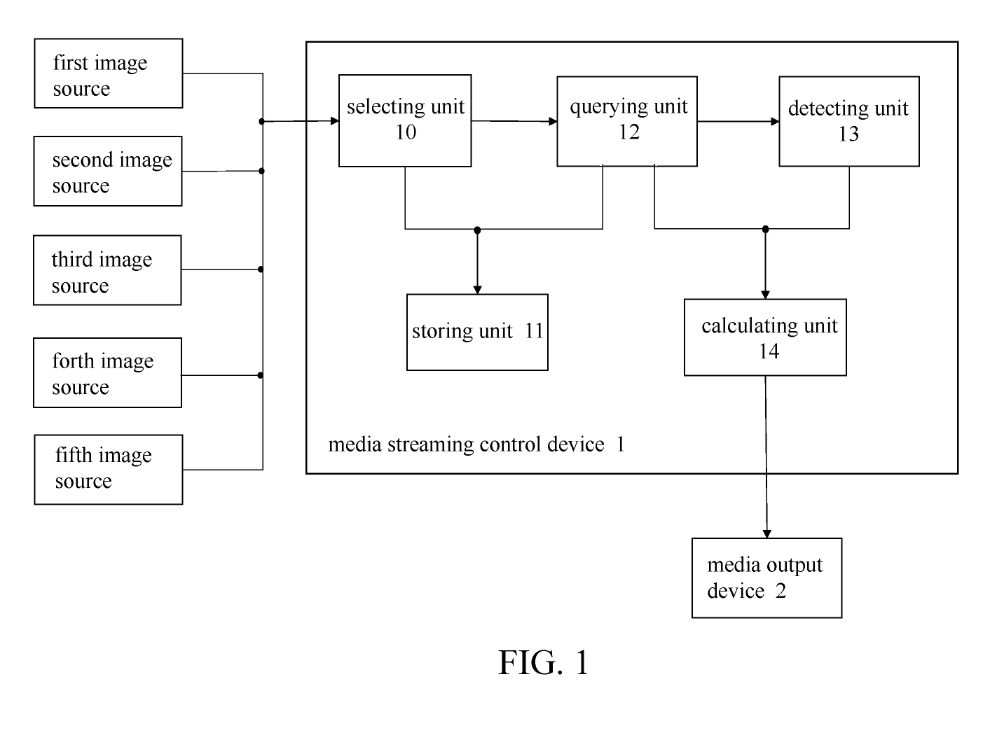

FIG. 1 is a block diagram of a media streaming control device 1 in accordance with a first embodiment of the present invention. As shown in FIG. 1, the media streaming control device 1 runs in combination with a media output device 2. The media streaming control device 1 receives one or a plurality of media sources from one or a plurality of media streaming platforms and sets parameters for the media sources. Subsequently, the media streaming control device 1 transmits the media sources to the media output device 2 upon completion of setting, and the media output device 2 plays simultaneously.

Furthermore, the media streaming control device 1 includes a selecting unit 10, a storing unit 11, an querying unit 12, a detecting unit 13 and a calculating unit 14. A user selects one or a plurality of media streaming platforms through the selecting unit 10 by means of network connection, and selects the media source (a streaming film or streaming music) to be played from the selected media streaming platforms. In the first embodiment, the media sources 1-5 which are from the media streaming platforms including Facebook, YouTube, Twitch, Twitch and NicoNico are selected to play. Herein, the user selects the platform Twitch to play two streaming films or the streaming music (the media sources 3-4). It is to be noted, the term “media” in the present invention may be interpreted as multimedia, which includes audiovisual or video and audio.

Moreover, the user logs in the selected media streaming platform with the account number through the selecting unit 10. In the embodiment, the storing unit 11 may record each previous account number and each previous password that are used by the user to log in the selected streaming platform, therefore the user may read out the account number and the password recorded in the storing unit 11 through the selecting unit 10, without inputting the account number and the password again if the user had logged in the platform that is selected this time previously.

Subsequently, the querying unit 12 may read out a list of the streaming platforms selected last time in the storing unit 11, and compare with the streaming platforms selected this time. If the streaming platforms, which are selected this time have been selected last time, the querying unit 12 may further read out the set media parameters of the selected streaming platforms when used last time. The media parameters may include but are not limited to resolution, bit-rate and frame-rate of an image part, and the bit-rate of an audio part in the media source. The user may set the media source which is played this time with the media parameters which are set last time. On the other hand, the user may also calculate in real time with the media streaming control device 1 in accordance with software and hardware performances of the personal calculating device at present and the parameter limitations of the selected streaming platform, to acquire one set of optimized media parameters and accordingly set the media source which is to be played this time.

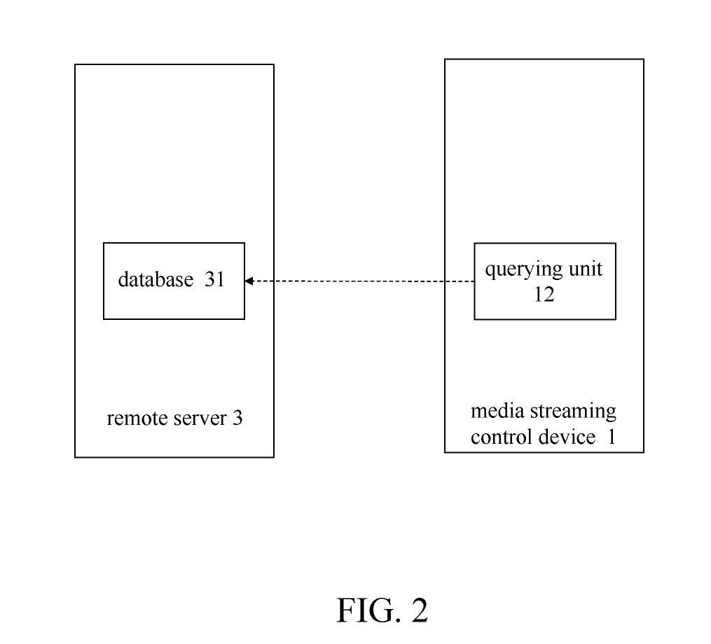

FIG. 2 is a schematic diagram of an inquiry mode of the querying unit 12 of the media streaming control device 1 in the first embodiment of the present invention. As shown in FIG. 2, media parameter limitations of each streaming platform may be recorded in a database 31 of a remote server 3 in advance, and the querying unit 12 of the local media streaming control device 1 may inquire the database 31 through a network to acquire the media parameter limitations. An inquiry result, for example, is shown in Table 1: a maximum image resolution and a minimum image resolution of the streaming platform (Facebook) of a first image source are 1920×1080 and 320×180 respectively, a maximum image bit-rate and a minimum image bit-rate thereof are 4 Mbps and 0.3 Mbps respectively, a maximum image frame-rate and a minimum image frame-rate thereof are 30 fps and 15 fps respectively, and a maximum audio bit-rate and a minimum audio bit-rate thereof are 128 kbps and 32 kbps respectively.

On the other hand, the maximum image resolution and the minimum image resolution of the streaming platform (YouTube) of a second image source are 3840×2160 and 576×360 respectively, the maximum image bit-rate and the minimum image bit-rate thereof are 50 Mbps and 0.3 Mbps respectively, the maximum image frame-rate and the minimum image frame-rate thereof are 60 fps and 15 fps respectively, and the maximum audio bit-rate and the minimum audio bit-rate thereof are 128 kbps and 32 kbps respectively.

In addition, the maximum image resolutions and the minimum image resolutions of the streaming platforms (Twitch) of a third image source and a fourth image source are 1920×1080 and 576×360 respectively, the maximum image bit-rates and the minimum image bit-rates thereof are 6 Mbps and 0.4 Mbps respectively, the maximum image frame-rates and the minimum image frame-rates thereof are 60 fps and 15 fps respectively, and the maximum audio bit-rates and the minimum audio bit-rates thereof are 128 kbps and 32 kbps respectively.

Moreover, the maximum image resolution and the minimum image resolution of the streaming platform (NicoNico) of a fifth image source are 1280×720 and 320×180 respectively, the maximum image bit-rate and the minimum image bit-rate thereof are 1.5 Mbps and 0.3 Mbps respectively, the maximum image frame-rate and the minimum image frame-rate thereof are 30 fps and 15 fps respectively, and the maximum audio bit-rate and the minimum audio bit-rate thereof are 64 kbps and 32 kbps respectively

TABLE 1

| | streaming | streaming | streaming | streaming |
|---|---|---|---|---|
| | platform | platform | platform | platform |
| | Facebook | YouTube | Twitch | NicoNico |
| image | 1920 × 1080 | 3840 × 2160 | 1920 × 1080 | 1280 × 720 |
| resolution | 1280 × 720 | 1920 × 1080 | 1680 × 1050 | 1152 × 864 |
| | 1152 × 864 | 1280 × 720 | 1440 × 900 | 1024 × 768 |
| | . | . | . | . |
| | . | . | . | . |
| | . | . | . | . |
| | 352 × 240 | 640 × 480 | 640 × 480 | 352 × 240 |
| | 320 × 240 | 640 × 360 | 640 × 360 | 320 × 240 |
| | 320 × 180 | 576 × 360 | 576 × 360 | 320 × 180 |
| image bit-rate | 0.3-4 | 0.3-50 | 0.4-6 | 0.3-1.5 |
| (Mbps) | | | | |
| image | 30 | 60 | 60 | 30 |
| frame-rate | 29.97 | 59.94 | 59.94 | 29.97 |
| (fps) | 25 | 50 | 50 | 25 |
| | . | . | . | . |
| | . | . | . | . |
| | . | . | . | . |
| | 15 | 15 | 15 | 15 |
| audio bit-rate | 128 | 128 | 128 | |
| (kbps) | 96 | 96 | 96 | 64 |
| | 64 | 64 | 64 | 32 |
| | 32 | 32 | 32 | |

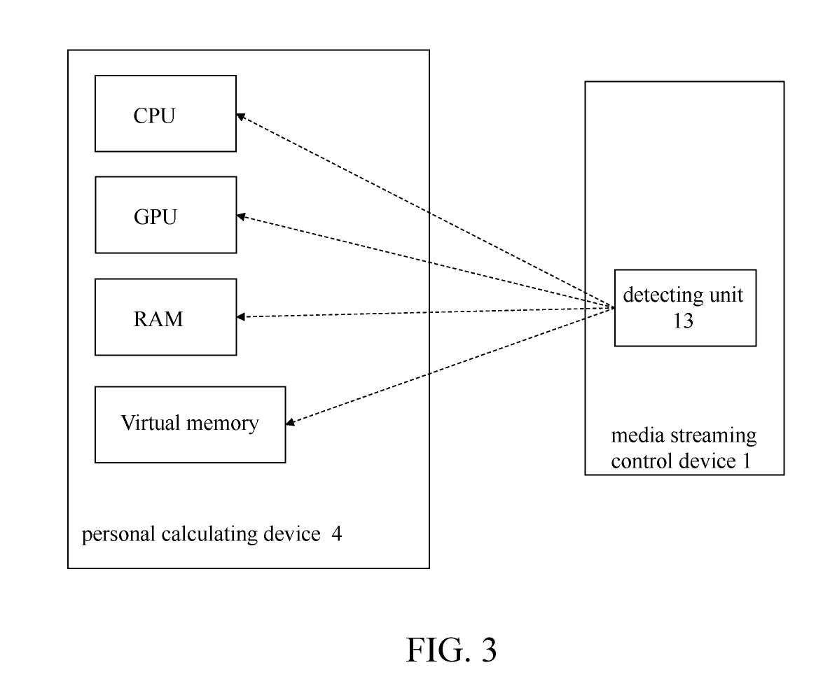

FIG. 3 is a schematic diagram of a detecting mode of the detecting unit 13 of the media streaming control device 1 in the first embodiment of the present invention. As shown in FIG. 3, the detecting unit 13 of the media streaming control device 1 may detect and evaluate hardware and software performances of a local personal calculating device 4 and the above-mentioned media output device 2. For example, main frequency (clk) of a Central Processing Unit (CPU) of the personal calculating device 4, performance of a display and plotting chipset or a Graphics Processing Unit (GPU) and a memory space of the personal calculating device 4 are detected, and a space capacity, which is still available in the memory is evaluated. Herein the memory space includes a main memory (RAM), a high-speed cache and a virtual memory, which is defined in a hard disk.

In the embodiment (the first embodiment), the detecting unit 13 may detect to acquire: the main frequency of the CPU of the personal calculating device 4 is 3.20 GHz, the display and plotting chipset is compatible with an image resolution of 800×600 to 1920×1080 and has an accelerated processing capacity of a 3D stereo image. In addition, the detecting unit 13 may detect to acquire: the main memory of the personal calculating device 4 has a total capacity of 4.00 GB, and a space of 500 MB in the hard disk is defined as the virtual memory. The detecting unit 13 may further evaluate to acquire: all memory space, which is still available for the personal calculating device 4 under the present using state, is about 2.00 GB. The detection result is shown in Table 2.

TABLE 2

| | CPU | GPU | RAM | virtual memory |
|---|---|---|---|---|
| main | 3.20 GHz | — | — | — |
| frequency | | | | |
| compatible | — | 1920 × 1080 | — | — |
| with image | | 1600 × 900 | | |
| resolution | | 1440 × 900 | | |
| | | . | | |
| | | . | | |
| | | . | | |
| | | 800 × 600 | | |
| total capacity | — | — | 4.00 GB | 500 MB |

| | | | |
|---|---|---|---|
| available | — | — | 2.00 GB |
| capacity | | | |

Next, FIG. 1 is continuously used for reference. Herein, the calculating unit 14 receives the inquiry result of the querying unit 12 and an evaluation and evaluation result of the detecting unit 13 respectively, and calculates one set of optimized media parameters in accordance with the comparison result. Subsequently, the calculating unit 14 sets the media parameters of the media sources 1-5 respectively with the set of optimized media parameters, and simultaneously plays the media sources 1-5 through the media output device 2.

In the first embodiment, in view of hardware performance of the local personal calculating device 4, the main frequency of the CPU is 3.20 GHz, and the display and plotting chipset is compatible with the highest image resolution of 1920×1080 and has about 2.00 GB memory space available. The above-mentioned hardware performance may be classified into Level I (extremely excellent). On the other hand, in view of the respective media parameter limitation of each remote streaming platform selected by the user, a maximum image resolution of the streaming platform (Facebook) of a first image source is 1920×1080, and the maximum image frame-rate is 30 fps. The maximum image resolution of the streaming platform (YouTube) of a second image source is 3840×2160, and the maximum image frame-rate is 60 fps. The maximum image resolutions of the streaming platforms (Twitch) of a third image source and a fourth image source are 1920×1080, and the maximum image frame-rates are 60 fps. The maximum image resolution of the streaming platform (NicoNico) of a fifth image source is 1280×720, and the maximum image frame-rate is 30 fps.

According to the above-mentioned considerations, the personal calculating device 4 has the Level-I (extremely excellent) performance, and may still run smoothly when the media sources 1-5 are played simultaneously with respective maximum specification (maximum of respective media parameter). Accordingly, the calculating unit 14 may calculate one set of optimized media parameters through comparison and set all media parameters of the media sources 1-5 as the maximums, as shown in Table 3.

TABLE 3

| | first image | second image | third image | forth image | fifth image |
|---|---|---|---|---|---|
| | source | source | source | source | source |
| | (Facebook) | (YouTube) | (Twitch) | (Twitch) | (NicoNico) |
| image | 1920 × 1080 | 1920 × 1080 | 1920 × 1080 | 1920 × 1080 | 1280 × 720 |
| resolution | | | | | |
| image | 30 | 60 | 60 | 60 | 30 |
| frame-rate | | | | | |
| (fps) | | | | | |

It is to be noted particularly that the local personal calculating device 4 is compatible with the resolution of 1920×1080 only although the streaming platform (YouTube) of the second image source is compatible with the maximum image resolution of 3840×2160. Therefore, in the optimized media parameters shown in the Table 3, the image resolution of the second image source (from YouTube) is still set to 1920×1080 only.

In addition, the detecting unit 13 may further detect and evaluate the performance of an operating system or software of the local personal calculating device 4. For example, in the first embodiment, the detecting unit 13 may further evaluate to acquire: the personal calculating device 4 is compatible with an image encoder of NVIDA or QSV in the aspect of software capability. Accordingly, in the optimized media parameters calculated by the calculating unit 4, an optimal suggestion of the available image encoder may be further provided, as shown in Table 4.

TABLE 4

| | first image | second image | third image | forth image | fifth image |
|---|---|---|---|---|---|
| | source | source | source | source | source |
| | (Facebook) | (YouTube) | (Twitch) | (Twitch) | (NicoNico) |
| image | 1920 × 1080 | 1920 × 1080 | 1920 × 1080 | 1920 × 1080 | 1280 × 720 |
| resolution | | | | | |
| image | 30 | 60 | 60 | 60 | 30 |
| frame-rate | | | | | |
| (fps) | | | | | |
| image | NVIDA | NVIDA | NVIDA | NVIDA | QSV |
| encoder | | | | | |

If the personal calculating unit 4 or the image output device has poor hardware performance in the detection and evaluation result of the detecting unit 13, it is recommended that the user should bring down parameter setting values of some items of part of media sources in the optimized media parameters which are calculated by the calculating unit 14, and streaming quality of part of media sources should be sacrificed to maintain stability of the whole streaming playing. Detailedly, in a second embodiment, the detecting unit 13 detects: the main frequency of the CPU of the personal calculating device 4 is 2.00 GHz, the display and plotting chipset is compatible with the maximum image resolution of 1920×1080 and has about 1.00 GB memory space available at present. The above-mentioned hardware performance may be classified into Level II (General), while other implementation conditions are the same as those in the first embodiment. At the moment, in the optimized media parameters calculated by the calculating unit 14, it is recommended that the user should bring down the image frame-rates of the media sources 2-4 to 30 fps completely, as shown in Table 5.

TABLE 5

| | first image | second image | third image | forth image | fifth image |
|---|---|---|---|---|---|
| | source | source | source | source | source |
| | (Facebook) | (YouTube) | (Twitch) | (Twitch) | (NicoNico) |
| image | 1920 × 1080 | 1920 × 1080 | 1920 × 1080 | 1920 × 1080 | 1280 × 720 |
| resolution | | | | | |
| image | 30 | 30 | 30 | 30 | 30 |
| frame-rate | | | | | |
| (fps) | | | | | |
| image | NVIDA | NVIDA | NVIDA | NVIDA | QSV |
| encoder | | | | | |

Furthermore, if the personal calculating unit 4 or the image output device has the worse hardware performance in the detection and evaluation result of the detecting unit 13, it is recommended that the user should bring down the parameter setting values of more items in the optimized media parameters which are calculated by the calculating unit 14, or further bring down the parameter setting values of some items, to maintain stability of the whole streaming playing. Detailedly, in a third embodiment, the result detected by the detecting unit 13 is: the main frequency of the CPU of the personal calculating device 4 is 1.50 GHz, the display and plotting chipset is compatible with the maximum image resolution of 1280×720 and has about 1.00 GB memory space available at present. The above-mentioned hardware performance may be classified into Level III (minimum), while other implementation conditions are the same as those in the first embodiment. At the moment, in the optimized media parameters calculated by the calculating unit 14, it is recommended that the user should bring down the image frame-rates of the media sources 1-5 to 30 fps completely and bring down the resolutions to 1280×720 completely, as shown in Table 6.

TABLE 6

| | first image | second image | third image | forth image | fifth image |
|---|---|---|---|---|---|
| | source | source | source | source | source |
| | (Facebook) | (YouTube) | (Twitch) | (Twitch) | (NicoNico) |
| image | 1280 × 720 | 1280 × 720 | 1280 × 720 | 1280 × 720 | 1280 × 720 |
| resolution | | | | | |
| image | 30 | 30 | 30 | 30 | 30 |
| frame-rate | | | | | |
| (fps) | | | | | |
| image | NVIDA | NVIDA | NVIDA | NVIDA | NVIDA |
| encoder | | | | | |

In other embodiments, the resolution of an media input source may be used for reference, to generate a set of optimized media parameters. By referring to the resolution of the media input source, a corresponding weight W is given to each resolution parameter selected by the user, respectively. Detailedly, in a fourth embodiment, the resolution of the media input source is 1920×1080, a maximum weight W1 is given to an option of 1920×1080 in the available resolution parameters, a medium weight W2 is given to the resolution option (16:9), a second medium weight W3 is given to the resolution option which is the closest to 16:9 (for example the resolutions 20:9 and 5:4), and a minimum weight W4 is given to other resolution option. Because the resolution parameter option 1920×1080 has the maximum weight W1, it is recommended that the user should set the image resolutions of the media sources 1-4 (Facebook, YouTube, Twitch and Twitch) to 1920×1080 in the generated optimized media parameters, as shown in Table 7.

It is to be noted particularly that the maximum image resolution of the streaming platform (NicoNico) of the fifth media source is limited to 1280×720 in a fourth embodiment. Because the streaming platform (NicoNico) is not compatible with a resolution 1920×1080 of the maximum weight W1, it is recommended only that the user should set the resolution parameter of the fifth media source (from NicoNico) to 16:9 having the medium weight W2, namely 1280×720, as shown in Table 7.

TABLE 7

| | first image | second image | third image | forth image | fifth image |
|---|---|---|---|---|---|
| | source | source | source | source | source |
| | (Facebook) | (YouTube) | (Twitch) | (Twitch) | (NicoNico) |
| image | 1920 × 1080 | 1920 × 1080 | 1920 × 1080 | 1920 × 1080 | 1280 × 720 |
| resolution | | | | | |
| image | 30 | 30 | 30 | 30 | 30 |
| frame-rate | | | | | |
| (fps) | | | | | |
| image | NVIDA | NVIDA | NVIDA | NVIDA | NVIDA |
| encoder | | | | | |

In summary, from the first embodiment to the fourth embodiment, the calculating unit 14 of the media streaming control device 1 generates one set of optimized media parameters through automatic comparison and calculation. However, the present invention is not limited to that. The user may further set all parameters manually. For example, the user may not accept the suggestion of optimizing the parameter setting as shown in Table 7, and the user may want to bring down the resolution of part of media sources to make the personal calculating device 4 still be available to implement other applications or background processing. At the moment, the user may manually set the resolutions of all media sources voluntarily and adjust the resolutions of the media sources 1-4 to 1600×900, as shown in Table 8.

TABLE 8

| | first image | second image | third image | forth image | fifth image |
|---|---|---|---|---|---|
| | source | source | source | source | source |
| | (Facebook) | (YouTube) | (Twitch) | (Twitch) | (NicoNico) |
| image | 1600 × 900 | 1600 × 900 | 1600 × 900 | 1600 × 900 | 1280 × 720 |
| resolution | | | | | |
| image | 30 | 30 | 30 | 30 | 30 |
| frame-rate | | | | | |
| (fps) | | | | | |
| image | NVIDA | NVIDA | NVIDA | NVIDA | NVIDA |
| encoder | | | | | |

It is to be noted particularly that, in the embodiments 1-4, the media streaming control device 1 stores the optimized media parameters (shown from Table 3 to Table 7, respectively) acquired through automatic calculation by the calculating unit 14 or the media parameters (as shown in Table 8) set by the user manually in the storing unit 11. When the user plays the streaming audio and video on the identical personal calculating device 4 next time and selects the identical streaming platform, the querying unit 12 may read out the media parameters which are stored last time, and the user may directly use the media parameters which are read out without setting again. In addition, the media streaming control device 1 may completely store all parameter settings of all streaming platforms which are selected last time. The user does not need to set the parameters again if selecting the identical streaming platform again next time. The advantages and functions of the present invention overcome the defects of a method of using multiple OBS applications in the known technology 1 (in the method of the technology 1, the parameter settings of one OBS application may be recorded only, and the user must set the parameters of the media sources of other streaming platforms again when playing next time).

In addition, from the first embodiment to the fourth embodiment of the present invention, individual parameter setting may be implemented in allusion to different media sources of different streaming platforms, thereby making each of the media sources have different parameters and more flexible. It is another unexpected function of the present invention. For example, as shown in Table 7, the image resolutions of the media sources 1-4 (from the platforms Facebook, YouTube, Twitch and Twitch, respectively) are set to 1920×1080, while the fifth media source (from NicoNico) may be set with different image resolutions (1280×720). The image resolution of the fifth media source may be set with the single application (namely the media streaming control device 1 of the present invention) and in accordance with different parameters. In this way, the different media sources of multiple streaming platforms may be played simultaneously, and multi-task function may be achieved accordingly.

Moreover, the present invention has another unexpected function: as shown in Table 1, the media parameter limitations of all streaming platforms are established and stored in a database 31 of a remote server 3 in advanced, and may be automatically queried by the querying unit 12 of the media streaming control device 1. Therefore, it is not necessary for the user to inquire the media parameter limitations of all streaming platforms manually, thereby reducing operation complexity of the user.

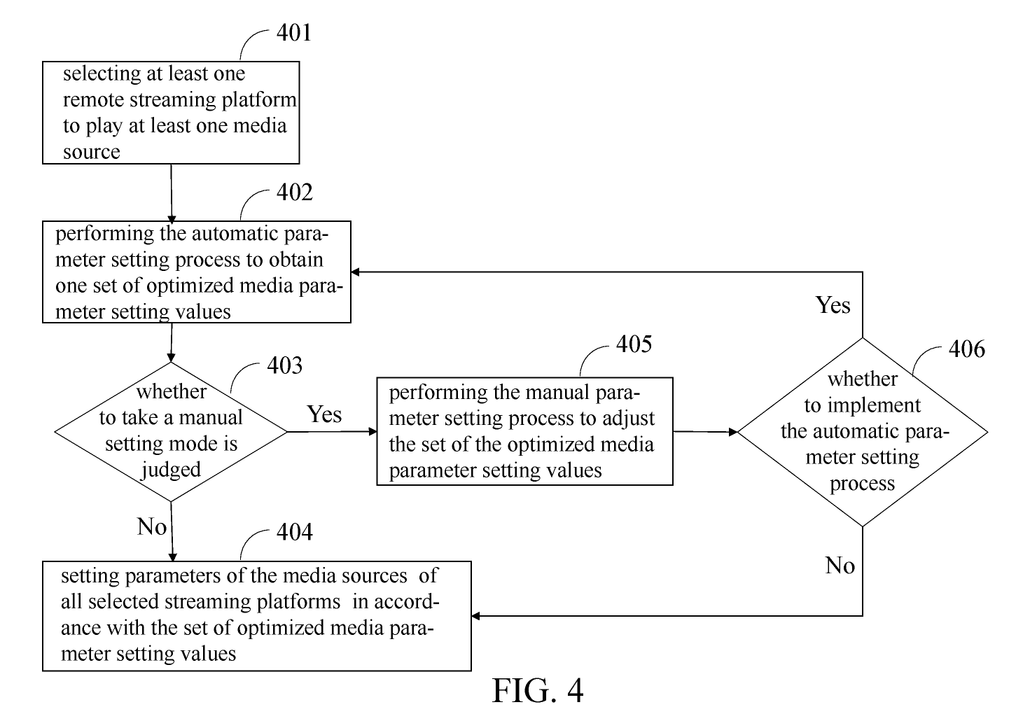

FIG. 4 is a flow chart of the media streaming control method in embodiments 1-4 of the present invention. As shown in FIG. 4, in a step 401, a remote streaming platform to be played is selected. For example, the media streaming platforms Facebook, YouTube, Twitch and NicoNico are selected, and media sources 1-5 are selected to play from the above-mentioned platforms, respectively. Herein, two streaming films including the third media source and the fourth media source are played on the platform Twitch. Moreover, an account number login process is implemented, so as to log in each of the selected streaming platforms. Furthermore, a list of the streaming platforms which are selected this time, login account numbers and passwords corresponding to all streaming platforms are stored in a storing unit 11 of a local personal calculating device 4, for use when logging in the identical streaming platform next time.

Next, an automatic parameter setting process P01 is implemented in a step 402. In the automatic parameter setting process P01, media parameter limitations of all streaming platforms corresponding to the media sources 1-5 may be queried, as shown in Table 1. In addition, hardware performance of the local personal calculating device 4 is detected, for example, main frequency of a Central processing unit, scope of image resolution compatible with a graphics processing unit, total capacity and a currently available capacity of a memory, as shown in Table 2. Moreover, performances of an operating system and software of the local personal calculating device 4 are detected, and accordingly a type of an image encoder which is recommended at present may be acquired through evaluation. Finally, a set of optimized media parameter setting values may be calculated through comparison in accordance with the above-mentioned inquiry result and detection result, as shown in Table 4.

Upon completion of the automatic parameter setting process P01, that whether to take a manual setting mode is judged subsequently in a step 403.

If the manual setting mode is not taken, in a step 404, parameters of the media sources (the media sources 1-5) of all selected streaming platforms are set in accordance with the set of optimized media parameter setting values (shown in Table 4) acquired in the step 402. In addition, the set of optimized media parameter setting values may be stored (in the storing unit 11 of the local personal calculating device 4 as well), to set the parameters of the media sources to be played with identical values if the identical streaming platform is selected next time.

On the other hand, if the manual setting mode is planed to take, in a step 405, a manual parameter setting process P02 may be implemented subsequently. In the manual parameter setting process P02, a user sets the parameters of all media sources of all streaming platforms voluntarily. For example, as shown in Table 8, the parameter is reduced to 1600×900, to facilitate the personal computer device 4 to process other applications or a background process with remaining arithmetic capability.

Upon completion of the manual parameter setting process P02, that whether to implement the automatic parameter setting process P01 again is judged subsequently in a step 406.

If planned to be implemented again, the automatic parameter setting process P01 should be implemented again after returning to the step 402.

On the other hand, if the automatic parameter setting process P01 is not planned to be implemented again, the parameters of the selected media sources 1-5 may be set in accordance with the parameters (shown in Table 8) which are manually set by the user in the step 405 after returning to the step 404. In addition, the parameters that are manually set are stored to set the parameters of the media sources to be played with the identical values if the identical streaming platform is selected next time.

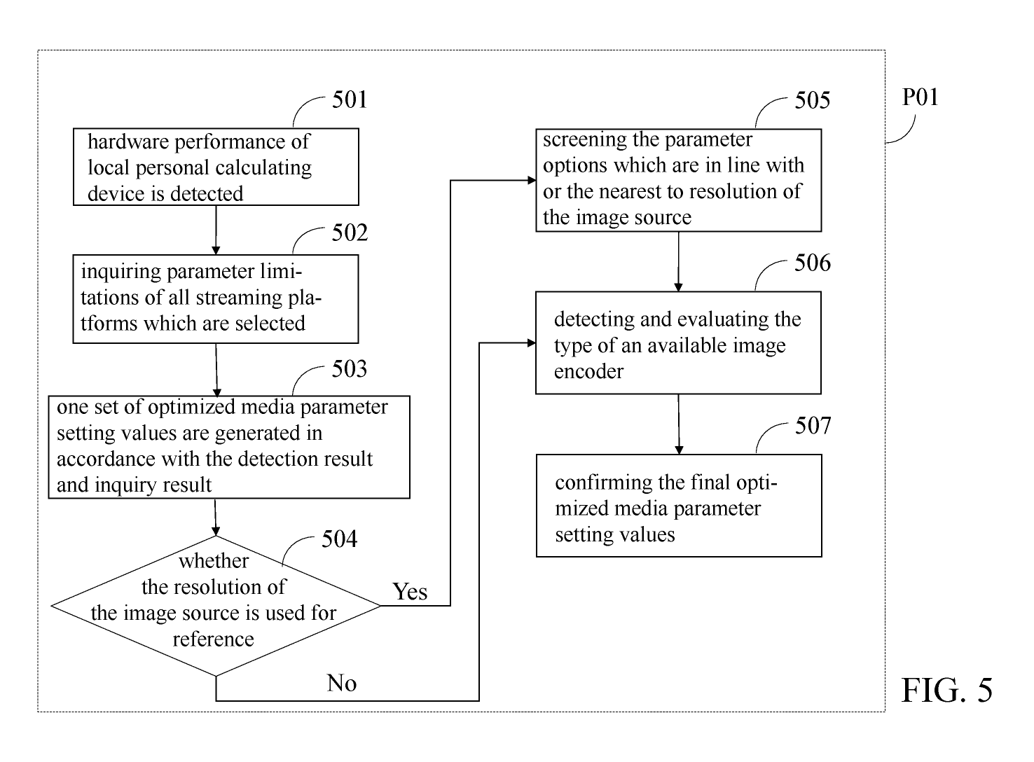

FIG. 5 is a flow chart of an automatic parameter setting process P01 in the media streaming control method of the embodiments 1-4 of the present invention. As shown in FIG. 5, hardware performance of a local personal calculating device 4 is detected first in a step 501. For example, according to a detection result, the main frequency of a central processing unit is 3.20 GHz, a maximum image resolution compatible with the display and plotting chipset is 1920×1080, total capacity of a main memory is 4.00 GB, a space of 500 MB in a hard disk is defined as the virtual memory, and all memory space which is still available is about 2.00 GB, as shown in Table 2.

Next, in a step 502, a database 31 of a remote server 3 is connected with a network, to accordingly inquire parameter limitations of all streaming platforms, which are selected in the step 401. For example, through inquiry, the maximum image resolution of the streaming platform (Facebook) of a first image source is 1920×1080, the maximum frame rate is 30 fps; the maximum image resolution of the streaming platform (YouTube) of a second image source is 3840×2160, the maximum frame rate is 60 fps; the maximum image resolutions of the streaming platforms (Twitch) of a third image source and a fourth image source are 1920×1080, the maximum frame rates are 60 fps; and the maximum image resolution of the streaming platform (NicoNico) of a fifth image source is 1280×720, the maximum frame rate is 30 fps, as shown in Table 1.

Next, in a step 503, one set of optimized media parameter setting values are calculated through comparison in accordance with the detection result acquired in the step 501 and the inquiry result acquired in step 502, as shown in Table 3.

Next, that whether the resolution of the image source is used for reference is judged in a step 504. In the embodiment, the resolution of the image source is 1920×1080.

If the resolution of the image source is planned to be used for reference, options which are in line with or the nearest to resolution 1920×1080 should be screened next in a step 505. Herein, a maximum weight W1 is given to the resolution option of 1920×1080, a medium weight W2 is given to the option of 16:9, a second medium weight W3 is given to the option which is the nearest to 16:9 (for example, the options of 20:9 and 5:4), and a minimum weight W4 is given to the options of other resolutions. Because the resolution parameter option 1920×1080 has the maximum weight W1, it is further recommended that the user should set the image resolutions of the media sources 1-4 (Facebook, YouTube, Twitch and Twitch) to the option 1920×1080 of the maximum weight W1 among the optimized media parameters generated in the step 503, as shown in Table 7.

The image resolution of the media sources 1-4 are further adjusted to 1920×1080. Next, performances of an operating system and software of the local personal calculating device 4 are detected in a step 506. Herein, the type of an available image encoder may be detected, for example, a NVIDA or a QSV encoder may be taken. While as shown in Table 7, it is recommended that the types of the encoders of the media sources 1-5 should be set as NVIDA.

On the other hand, the method skips to the step 506 directly when judging that the resolution of the image source would not be used for reference in the step 504, so as to detect the performances of the operating system and the software of the local personal computer device 4 while evaluating and recommending the available type of the image encoder.

Upon completion of the step 506, the final optimized media parameter setting values may be confirmed subsequently in a step 507, so as to complete the automatic parameter setting process P01.

Even though numerous characteristics and advantages of certain inventive embodiments have been set out in the foregoing description, together with details of the structures and functions of the embodiments, the disclosure is illustrative only. Changes may be made in detail, especially in matters of arrangement of parts, within the principles of the present disclosure to the full extent indicated by the broad general meaning of the terms in which the appended claims are expressed.

What is claimed is:

1. A media streaming control device, which is cooperated with a local media output device, comprising:
a selecting unit, which is for selecting at least one remote media streaming platform and at least one media source from the media streaming platforms;
a querying unit, which is for querying a media parameter limitation of the selected media streaming platform;
a detecting unit, which is for detecting the system performance of a local personal calculating device; and
a calculating unit, which is for calculating a set of optimized media parameters in accordance with the queried media parameter limitation and the detected system performance while setting the selected media sources in accordance with the set of optimized media parameters and outputting the media sources after setting through the local media output device.

2. The media streaming control device of claim 1, wherein the media parameters include image resolution, image bit-rate, image frame-rate or audio bit-rate of the media source.

3. The media streaming control device of claim 2, wherein the media parameter limitations are stored in a database of a remote server, and the querying unit may access to the database through network connection to inquire the media parameter limitations.

4. The media streaming control device of claim 3, wherein the system performance of the personal calculating device includes main frequency of a Central Processing Unit (CPU), scope of the image resolution compatible with a Graphics Processing Unit (GPU), memory capacity and type of an image encoder compatible with software.

5. The media streaming control device of claim 4, wherein the calculating unit calculates the set of optimized media parameters after choosing a maximum in an intersection of the media parameter limitations and the system performance.

6. The media streaming control device of claim 5, wherein the user being adjust the set of optimized media parameters manually.

7. The media streaming control device of claim 1, further comprising:
a storing unit, which is configured to store the set of optimized media parameters.

8. A media streaming control method, which is used to set media parameters of at least one media source output by a local media output device, comprising:
selecting at least one remote media streaming platform and at least one media source of the media streaming platforms;
implementing an automatic parameter setting process to generate one set of optimized media parameters automatically;
setting the selected media sources in accordance with the set of optimized media parameters; and
outputting the media sources after setting through the media output device.

9. The media streaming control method of claim 8, wherein the automatic parameter setting process comprises the following steps:
an media parameter limitation of the selected media streaming platform is queried automatically;
the system performance of a local personal calculating device is detected automatically; and
the set of optimized media parameters are calculated automatically in accordance with the queried media parameter limitations and the detected system performance.

10. The media streaming control method of claim 9, wherein the media parameters comprise image resolution, image bit-rate, image frame-rate or audio bit-rate of the media source.

11. The media streaming control method of claim 10, wherein the system performance of the personal calculating device includes main frequency of a Central Processing Unit (CPU), scope of the image resolution compatible with a Graphics Processing Unit (GPU), memory capacity and type of an image encoder compatible with software.

12. The media streaming control method of claim 11, wherein in the automatic calculation step of the automatic parameter setting process, the set of optimized media parameters are calculated by choosing a maximum in an intersection of the media parameter limitations and the system performance.

13. The media streaming control method of claim 12, further comprising:
performing a manual parameter setting process to adjust the set of optimized media parameters manually by a user.

14. The media streaming control method of claim 8, further comprising:
storing the set of optimized media parameters; and
the media parameters of at least one media source to be selected next time are set in accordance with the set of optimized media parameters that are stored this time when selecting the identical media streaming platform next time.

15. The media streaming control method of claim 8, further comprising:
storing a login account number and a password of the selected media streaming platforms; and
the account number and the password which are stored this time are taken to log in when selecting the identical media streaming platform next time.
